(19) United States
(12) Patent Application Publication
(10) Pub. No.: US 2009/0074550 A1
(43) Pub. Date: Mar. 19, 2009

(54) CARRIAGE POSITIONING MECHANISM AND CARRIAGE FOR COMPONENT MOUNTING APPARATUS

(75) Inventor: Kimiyuki Yamasaki, Fukuoka (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/208,121

(22) Filed: Sep. 10, 2008

(30) Foreign Application Priority Data
Sep. 13, 2007 (JP) 2007-237713
Sep. 13, 2007 (JP) 2007-237714

(51) Int. Cl. B66F 9/00

(52) U.S. Cl. 414/595

(57) ABSTRACT

Cam followers are rotatably provided in the periphery of a horizontal shaft of a feeder base corresponding to a positioning object portion of a carriage. Cam members are provided on the side of a component mounting apparatus and respectively include ascending slope surfaces coming into contact with the cam followers at a position close to the carriage and horizontal positioning surfaces continuously formed with the ascending slope surfaces. After the cam followers are brought into contact with the ascending slope surfaces of the cam members, the feeder base is pressed upward toward the component mounting apparatus by an air-pressure cylinder provided in the component mounting apparatus so that the cam followers roll from the ascending slope surfaces to the positioning surfaces of the cam members and the feeder base is placed on the positioning surfaces.

### BACKGROUND OF THE INVENTION

1. Field of the Invention

The present invention relates to a carriage positioning mechanism for a component mounting apparatus for positioning a positioning object portion of a carriage in a height direction when the carriage is coupled to the component mounting apparatus, a printing apparatus, or an inspection apparatus and a carriage for the component mounting apparatus.

2. Related Art

In the past, some of component mounting apparatuses, printing apparatuses, or inspection apparatuses are configured to be coupled to a parts feeder changing carriage or a carriage mounted with a personal computer and the like for checking an operation of the component mounting apparatus. In such a carriage, when the carriage is coupled to the component mounting apparatus, a positioning operation is carried out in a height direction so that a height of a positioning object portion of the carriage matches with a reference height of the component mounting apparatus. For example, for a case where the carriage provided with a feeder base mounted with a plurality of parts feeders is coupled to the component mounting apparatus, a technique is known in which a feeder base is configured to be elevatable with respect to a carriage body portion provided with a vehicle wheel, a wedge-shaped cam member having an ascending slope surface and a horizontal positioning surface continuously formed with the ascending slope surface is provided in a component mounting apparatus so as to protrude toward a carriage, and a cam follower is provided in the lower surface of the feeder base so that the cam follower rolls on the slope surface of the cam member in terms of an operation in which the carriage moves close to the component mounting apparatus and the feeder base moves upward up to a height of the positioning surface of the cam member and a part of the feeder base comes into contact with a reference member on the side of the component mounting-apparatus from the downside (Japanese Patent No. 3307024).

However, as described above, since the cam follower on the side of the carriage rolls on the slope surface of the cam member in terms of the operation in which the carriage moves close to the component mounting apparatus, the carriage needs to be pressed at a force against a force that the carriage moves on the slope surface of the cam member in a descending direction, thereby causing a problem in that the job requires heavy labor. Here, when the slope angle of the cam member is set to be small, the force for pressing the carriage is decreased; on the other hand protrusion degree of the cam member is increased due to the small slope angle. As a result, such a countermeasure has a limitation in practical use.

Additionally, in such a carriage, a power for operating a carriage-side device (a parts feeder, a personal computer, and the like) is obtained from a power source provided on the side of the component mounting apparatus in many cases. In this case, at the time of coupling or separating the carriage to or from the component mounting apparatus, an operator needs to attach or detach (insert or extract) an apparatus-side connector to or from a carriage-side connector, but such an operation is very troublesome. For this reason, a technique is known in which both connectors are fitted to each other in such a manner that the positioning object portion is moved upward by the carriage positioning mechanism and pressed against the reference member on the component mounting apparatus (JP-A-2000-244183).

However, in the carriage positioning mechanism for the component mounting apparatus described above, since the carriage is positioned with respect to the component mounting apparatus in a longitudinal direction and the positioning object portion is simply moved upward, there is no choice but to adopt a type in which the connectors are fitted to each other in a vertical direction. In such a type in which the connectors are fitted to each other in a vertical direction, waste or dust may enter the connector opened upward, thereby causing a problem such as a bad connection.

### SUMMARY OF THE INVENTION

Therefore, an object of the invention is to provide a carriage positioning mechanism and a carriage for a component mounting apparatus capable of facilitating a coupling operation in which the carriage is coupled to the component mounting apparatus.

Therefore, an object of the invention is to provide a carriage positioning mechanism for a component mounting apparatus capable of preventing waste or dust from entering a carriage-side connector and an apparatus-side connector which are coupled to each other upon positioning a positioning object portion of a carriage.

According to the first aspect of the invention, there is provided a carriage positioning mechanism for a component mounting apparatus for positioning a positioning object portion of a carriage in a height direction upon coupling the carriage to the component mounting apparatus, the mechanism including: a cam follower which is rotatably provided in a periphery of a horizontal shaft of the positioning object portion; a cam member which is provided in the component mounting apparatus and includes an ascending slope surface coming into contact with the cam follower when the carriage is close to the component mounting apparatus and a horizontal positioning surface continuously formed with the ascending slope surface; and an actuator which is provided in the component mounting apparatus and presses upward the positioning object portion of the carriage toward the component mounting apparatus after the cam follower comes into contact with the ascending slope surface of the cam member so that the cam follower rolls from the ascending slope surface to the positioning surface of the cam member and the positioning object portion is placed on the positioning surface of the cam member.

According to second of the invention, there is provided a carriage for a component mounting apparatus having a positioning object portion positioned in a height direction upon being coupled to the component mounting apparatus, the carriage including: a cam follower which is rotatably provided in the periphery of a horizontal shaft of the positioning object portion and comes into contact with an ascending slope surface of a cam member provided in the component mounting apparatus at a position close to the component mounting apparatus, wherein the cam follower comes into contact with the ascending slope surface of the cam member and the positioning object portion is pressed upward toward the component mounting apparatus by an actuator provided in the component mounting apparatus so that the cam follower rolls from the ascending slope surface of the cam member to a horizontal positioning surface continuously formed with the ascending slope surface, thereby placing the positioning object portion on the positioning surface of the cam member.

According to third aspect of the invention, there is provided a carriage positioning mechanism for a component mounting apparatus for positioning a positioning object portion of a carriage in a height direction upon coupling the carriage to the component mounting apparatus, the mechanism including: a cam follower rotatably provided in a periphery of a horizontal shaft of the positioning object portion; a cam member provided in the component mounting apparatus and including an ascending slope surface coming into contact with the cam follower when the carriage is close to the component mounting apparatus and a horizontal positioning surface continuously formed with the ascending slope surface; an actuator which is provided in the component mounting apparatus and presses upward the positioning object portion of the carriage toward the component mounting apparatus after the cam follower comes into contact with the ascending slope surface of the cam member so that the cam follower rolls from the ascending slope surface to the positioning surface of the cam member and the positioning object portion is placed on the positioning surface of the cam member; a carriage-side connector provided in the positioning object portion of the carriage; and an apparatus-side connector provided in the component mounting apparatus and fitted to the carriage-side connector in a horizontal direction, wherein when the cam follower rolls on the positioning surface of the cam member, the positioning object portion of the carriage moves in a horizontal direction so that the carriage-side connector is fitted to the apparatus-side connector in a horizontal direction.

According to the invention, since the actuator performs the operation in which the carriage is pressed upward against a force that the cam follower provided in the positioning object portion of the carriage moves on the ascending slope surface of the cam member in a descending direction, it is possible for an operator to facilitate the coupling operation in which the carriage is coupled to the component mounting apparatus. Additionally, since the actuator is provided on the side of the component mounting apparatus instead of the side of the carriage, it is not necessary to provide the actuator for each carriage, thereby reducing a manufacture cost.

According to the invention, a type is used in which the carriage-side connector is fitted to the apparatus-side connector in a horizontal direction, and the both connectors are coupled to each other by using a movement in which the positioning object portion moves in a horizontal direction when the cam follower provided in the positioning object portion of the carriage rolls on the horizontal positioning surface of the cam member. For this reason, waste or dust hardly enters both the carriage-side connector and the apparatus-side connector, thereby preventing an occurrence of a problem such as a bad connection.

### BRIEF DESCRIPTION OF THE DRAWINGS

FIG. 1 is a top view showing a component mounting apparatus according to an embodiment of the invention.

FIG. 2 is a partial perspective view showing a carriage coupling part of the component mounting apparatus according to the embodiment of the invention.

FIG. 3 is a partial front view showing the carriage coupling part of the component mounting apparatus according to the embodiment of the invention.

FIG. 4 is a perspective view showing a carriage according to the embodiment of the invention.

FIG. 5 is a perspective view showing the carriage according to the embodiment of the invention.

FIG. 6 is a perspective view showing a feeder base of the carriage according to the embodiment of the invention.

FIG. 7 is a partial perspective view showing the carriage coupling part of the component mounting apparatus according to the embodiment of the invention.

FIG. 8 is a partial perspective view showing the carriage coupling part of the component mounting apparatus according to the embodiment of the invention.

FIG. 9 is a block diagram showing a control system of the carriage coupling part of the component mounting apparatus according to the embodiment of the invention.

FIGS. 10A and 10B are views showing a state where the carriage according to the embodiment of the invention is close to the carriage coupling part of the component mounting apparatus.

FIG. 11 is a partial perspective view showing the carriage coupling part of the component mounting apparatus according to the embodiment of the invention.

FIG. 12 is a partial perspective view showing the carriage coupling part of the component mounting apparatus according to the embodiment of the invention.

FIGS. 13A, 13B, and 13C are views showing a state where the feeder base of the carriage according to the embodiment of the invention is coupled to the carriage coupling part of the component mounting apparatus.

### DETAILED DESCRIPTION OF THE PREFERRED EMBODIMENTS

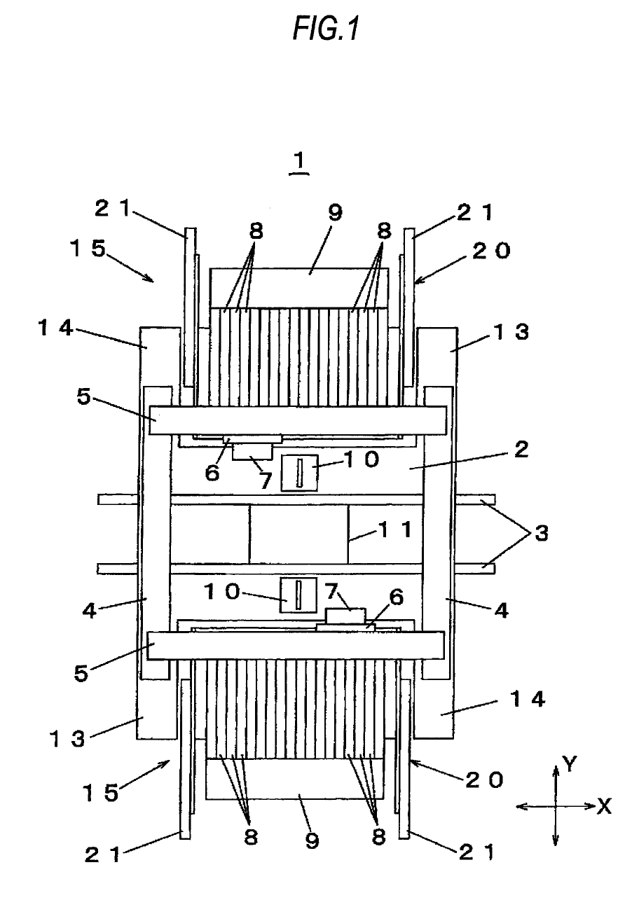

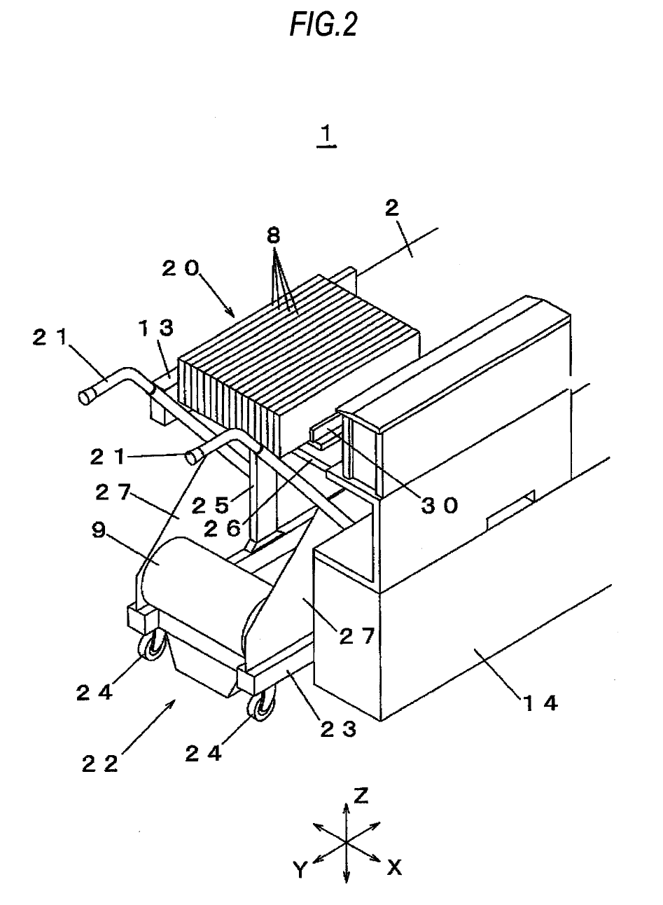

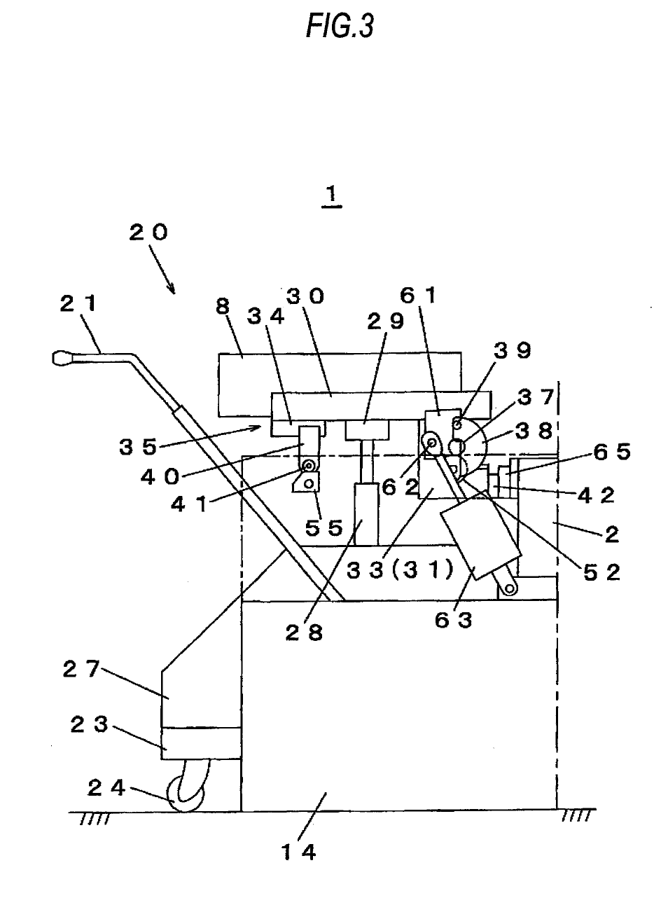

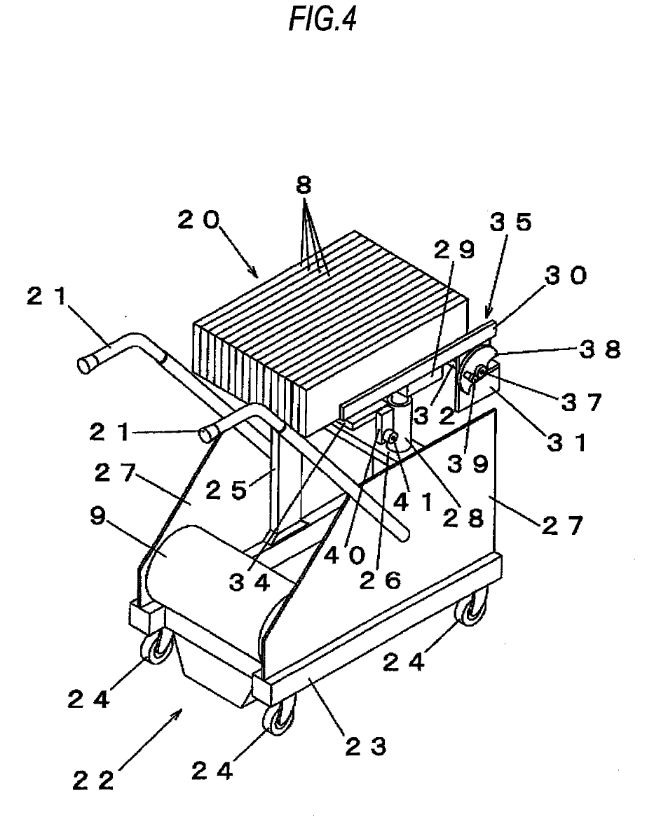

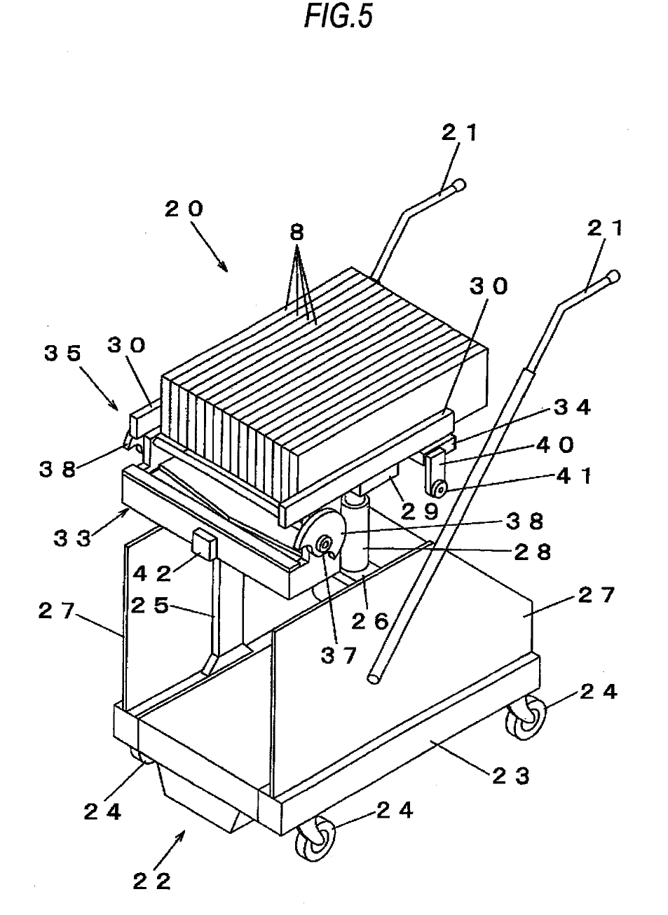

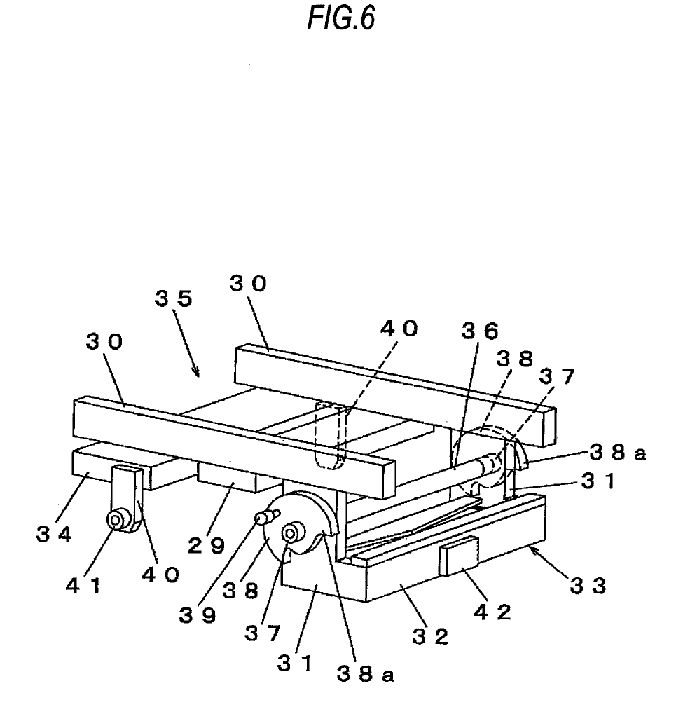

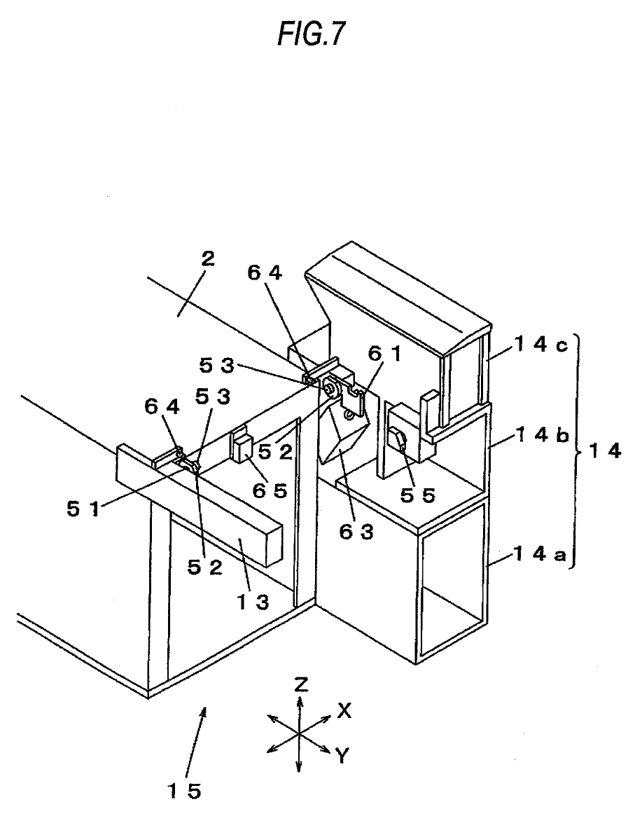

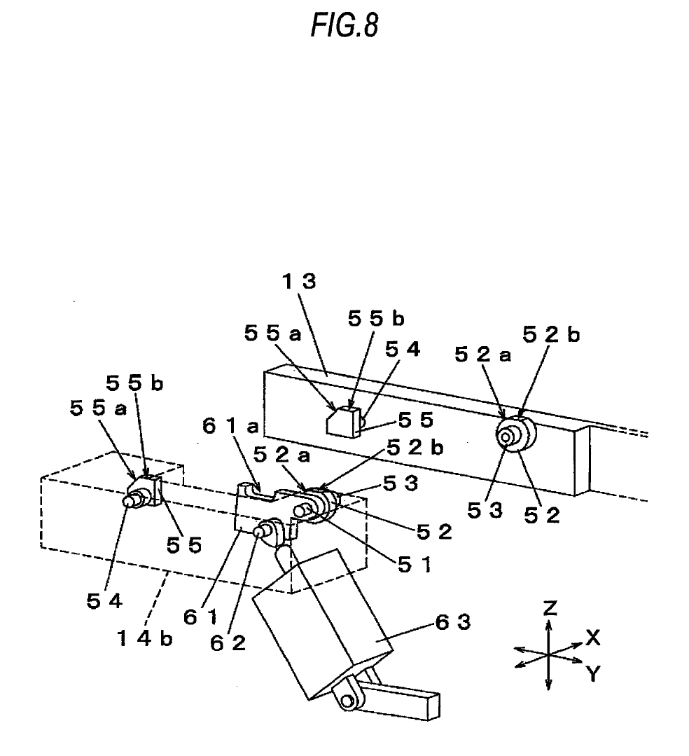

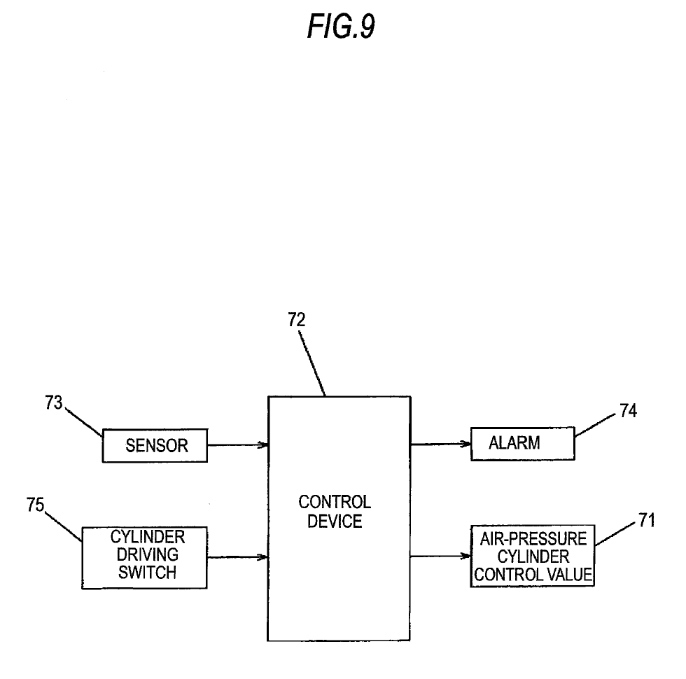

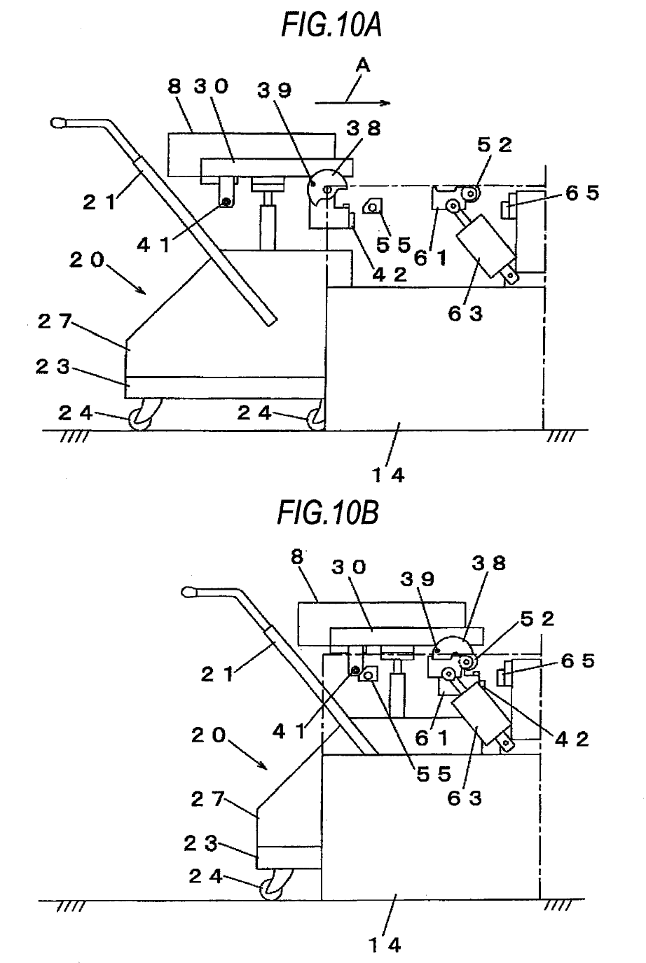

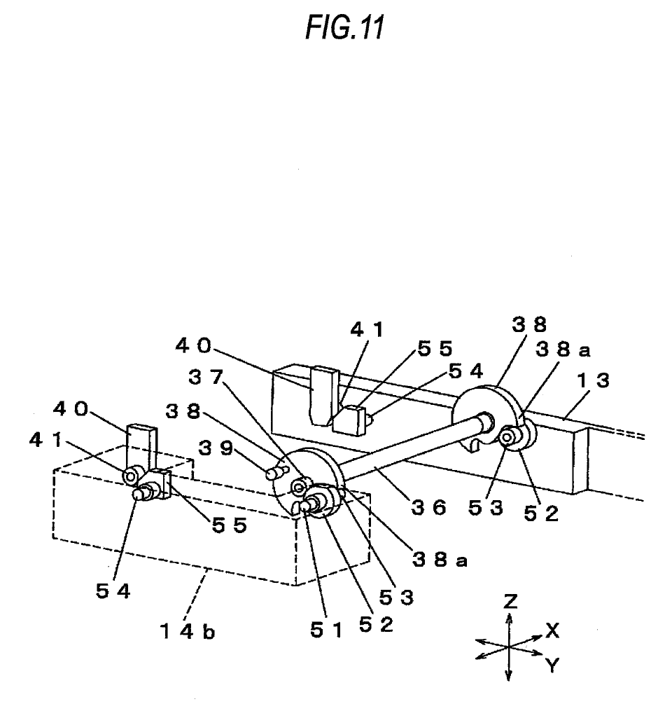

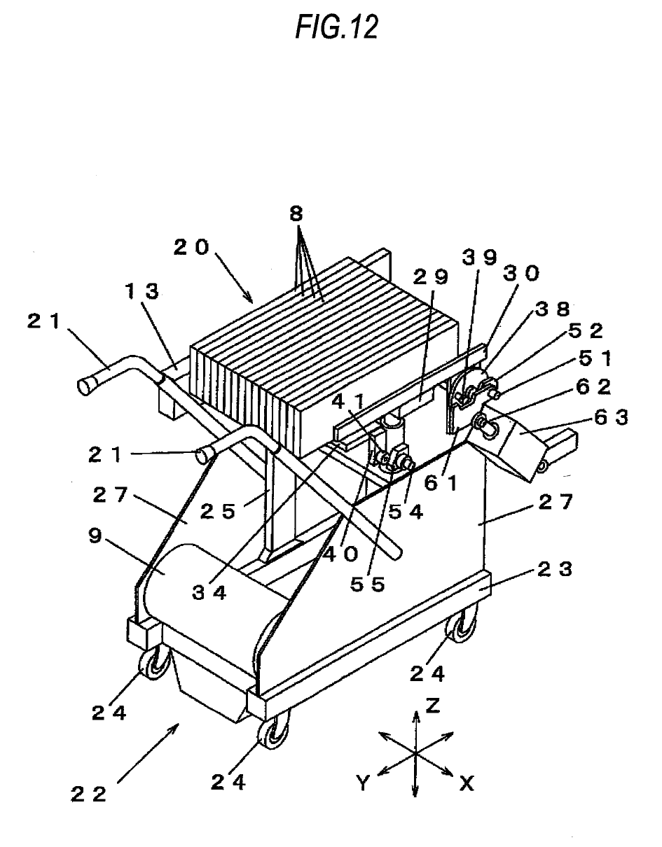

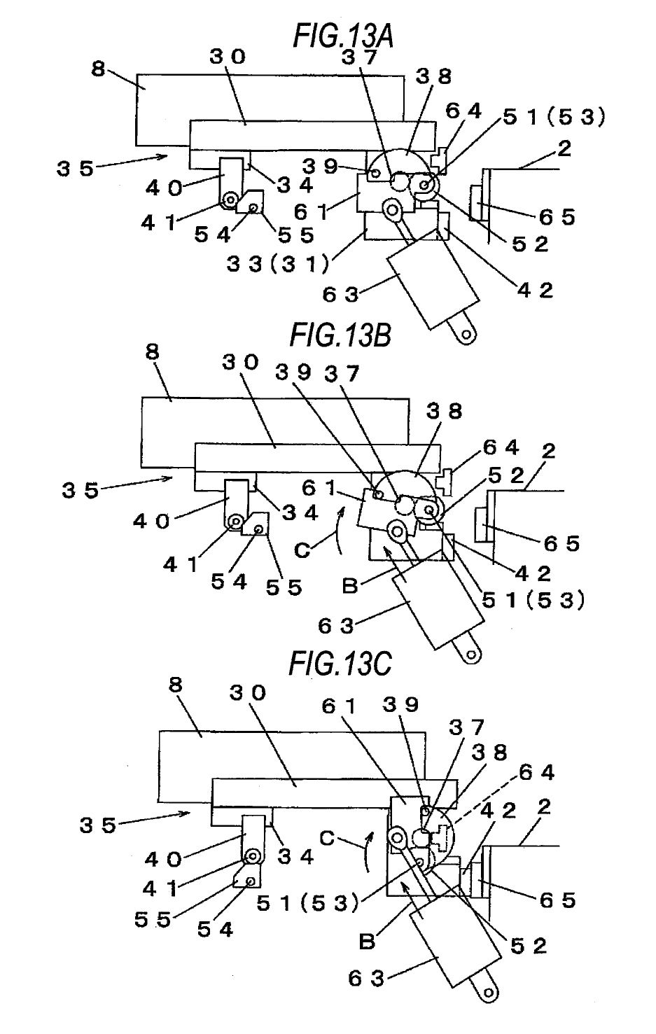

Hereinafter, an exemplary embodiment of the invention will be described with reference to the accompanying drawings. FIG. 1 is a top view showing a component mounting apparatus according to an embodiment of the invention. FIG. 2 is a partial perspective view showing a carriage coupling part of the component mounting apparatus according to the embodiment of the invention. FIG. 3 is a partial front view showing the carriage coupling part of the component mounting apparatus according to the embodiment of the invention. FIGS. 4 and 5 are perspective views showing a carriage according to the embodiment of the invention. FIG. 6 is a perspective view showing a feeder base of the carriage according to the embodiment of the invention. FIG. 7 is a partial perspective view showing the carriage coupling part of the component mounting apparatus according to the embodiment of the invention. FIG. 8 is a partial perspective view showing the carriage coupling part of the component mounting apparatus according to the embodiment of the invention. FIG. 9 is a block diagram showing a control system of the carriage coupling part of the component mounting apparatus according to the embodiment of the invention. FIGS. 10A and 10B are views showing a state where the carriage according to the embodiment of the invention is close to the carriage coupling part of the component mounting apparatus. FIGS. 11 and 12 are partial perspective views showing the carriage coupling part of the component mounting apparatus according to the embodiment of the invention. FIGS. 13A, 13B, and 13C are views showing a state where the feeder base of the carriage according to the embodiment of the invention is coupled to the carriage coupling part of the component mounting apparatus.

In FIGS. 1, 2, and 3, a component mounting apparatus 1 as an example of a component mounting apparatus includes a substrate carrying path 3 which is provided on the upper surface of a base 2 so as to extend in an X-axis direction in a horizontal plane and two parallel Y-axis tables 4 which are provided above the substrate carrying path 3 so as to extend in a Y-axis direction perpendicular to the substrate carrying paths 3 in a horizontal plane. Two parallel X-axis tables 5 are provided above the two Y-axis tables 4, and both end portions of each X-axis table 5 are supported to the Y-axis tables 4 so as to be movable in a Y-axis direction. A movement stage 6 is provided in each X-axis table 5 so as to be movable along the X-axis table 5, and a head portion 7 having a plurality of nozzles (not shown) is provided in each movement stage 6.

A plurality of parts feeders (hereinafter, referred to as tape feeders) 8 is provided in both end portions of the base 2 in a Y-axis direction so as to protrude outward in a Y-axis direction. Each parts feeder 8 intermittently transfers a tape (not shown) drawn out from a reel 9 (see FIG. 2) provided therebelow (provided in a parts feeder changing carriage 20 described below) so as to supply parts (electronic parts not shown) included in the tape at a uniform interval to a predetermined pick-up position on the parts feeder 8.

Each head portion 7 moves in the horizontal plane in terms of the movement of the X-axis table 5 in a Y-axis direction and the movement of the movement stage 6 in an X-axis direction, and picks up the parts, supplied to the pick-up position by the parts feeder 8, in terms of a vacuum-absorption of the nozzles. Then, the pick-up parts is recognized by a parts camera 10 provided in the base 2, and is mounted to a substrate 11 positioned with respect to the substrate carrying path 3 in terms of a predetermined position correcting operation.

Both end portions of the base 2 in a Y-axis direction are provided with a carriage coupling part 15 interposed between left and right carriage support members (a left carriage support member 13 and a right carriage support member 14) extending in a Y-axis direction so as to be opposed to each other in an X-axis direction. The carriage coupling part 15 is coupled to the parts feeder changing carriage (hereinafter, simply referred to as a carriage) 20, and the plurality of parts feeders 8 which supplies the parts to the head portion 7 is mounted to the carriage 20. That is, the parts feeders 8 are configured to be integrally attached or detached by coupling or separating the carriage 20 to or from the carriage coupling part 15 of the base 2.

In FIGS. 4, 5, and 6, the carriage 20 includes a carriage body portion 22 which is movable in terms of an operation of left and right handles 21. The carriage body portion has a plurality of vehicle wheels 24 provided in the lower portion of a horizontal base portion 23, left and right-side pillars 25 are provided in the upper surface of the base portion 23 so as to extend upward, and a horizontal member 26 is suspended on the left and right-side pillars 25 in a transverse direction of the carriage body portion 22. Left and right-side plates 27 are provided in both left and right end portions of the base portion 23 so as to extend upward along the left and right-side pillars 25. The left and right handles 21 are mounted to the side pillars 25 with the side plates 27 interposed therebetween. A vertical pillar 28 is provided at the left and right portions of the horizontal member 26 in an extensible manner in a vertical direction so as to extend upward, and an elevation plate 29 is provided in horizontal in the upper end portions of the vertical pillars 28 so as to extend in a transverse direction of the carriage body portion 22.

The lower surfaces of the center portions of left and right longitudinal members 30 extending in a longitudinal direction (hereinafter, for the convenience of the description, a forward direction indicates a direction facing the base 2 and a backward direction indicates a direction moving away from the base 2) of the carriage body portion 22 are supported by the left and right end portions of the elevation plate 29. At a position below the left and right longitudinal members 30 in a forward direction, a front bridge member 33 is constituted by a downward extension portion 31 which extends downward and a bridge portion 32 in which the left and right downward extension portions 31 extend in a transverse direction of the carriage body portion 22. Additionally, at a position below the left and right longitudinal members 30 in a backward direction, a rear bridge member 34 extends in a transverse direction of the carriage body portion 22. The elevation plate 29, the longitudinal members 30, the front bridge member 33, and the rear bridge member 34 constitute a parts feeder base 35 in which the plurality of parts feeders 8 is mounted in parallel. Since the elevation table 29 of the feeder base 35 is mounted to the upper end portions of the vertical pillars 28 which are extensible in a vertical direction as described above, the whole part of the feeder base 35 is configured to be elevatable with respect to the carriage body portion 22.

In FIG. 6, a connection shaft 36 extending in a transverse direction (i.e., a horizontal direction) of the carriage body portion 22 is rotatably supported to the left and right downward extension portions 31 of the feeder base 35. At both end portions of the connection shaft 36 protruding outward from the downward extension portions 31, left and right front cam followers 37 rotatably provided in a shaft (i.e., a horizontal shaft) of the connection shaft 36 so as to be relatively rotatable with respect to the connection shaft 36.

In both end portions of the connection shaft 36 protruding outward from the downward extension portions 31, at the inner portions (the portions close to the center of the feeder base 35) of the left and right front cam followers 37, lever members 38 are fixed to the connection shaft 36. Hook-shaped claw portions 38a are provided in the front portions of the left and right lever members 38 so as to be recessed downward. Additionally, a protrusion portion 39 is provided in the right lever member 38 so as to protrude outward.

A pendent member 40 is provided in both end portions of the rear bridge member 34 of the feeder base 35 in a pendent manner, and at the outside portions of the left and right pendent members 40, a backward cam follower 41 is rotatably provided in a periphery of a horizontal shaft parallel to the connection shaft 36.

In FIG. 7, the left carriage support member 13 constituting the carriage coupling part 15 extends from the base 2 so as to be biased in a Y-axis direction, and the right carriage support member 14 includes a lower-stage member 14a, an intermediate-state member 14b, and an upper-stage member 14c, which extend in a Y-axis direction.

In FIGS. 7 and 8, a front protrusion 51 is provided at the front portions of the left carriage support member 13 and the right carriage support member 14 (the intermediate-stage member 14b), which are opposed to each other in an X-axis direction, so as to protrude inward, and the left and right front protrusions 51 are fixed to the front cam members 52, respectively. The left and right front cam members 52 each includes an ascending slope surface 52a formed by an upper half portion (a surface inclined from the rear to the front) of a circular-arc surface about the center shaft of the front protrusion 51 and a horizontal positioning surface 52b continuously formed with the ascending slope surface 52a as a cam surface. Then, at the opposed portions of the left and right front cam members 52, a claw lock member 53 having a cylindrical surface coaxially formed with the front protrusion 51 is provided.

A rear protrusion 54 is provided at the opposed rear portions of the left carriage support member 13 and the intermediate-stage member 14b in an X-axis direction so as to protrude inward, and a rear cam member 55 is fixed to the left and right rear protrusions 54. The left and right rear cam members 55 each includes an ascending slope surface 55a formed by a slope surface inclined from the backward to the front in an inclined direction and a horizontal positioning surface 55b continuously formed with the ascending slope surface 55a.

Additionally, a flat plate-shaped swingable member 61 is provided at the right front protrusion 51 so as to be swingable within the upper and lower surfaces, and a recessed portion 61a is provided in the upper surface of the swingable member 61 so as to be recessed downward (FIG. 8). The lower end portion of the swingable member 61 is pivoted to the right carriage support member 14, and the upper end portion thereof is swingable in an X-axis direction in terms of an extending operation of an air-pressure cylinder 63 (actuator) pivoted to a pivot portion 62 at the rear lower position of the swing center (i.e., the right front protrusion 51) of the swingable member 61. The air-pressure cylinder 63 is operated by the pressed air supplied from an air-pressure source (not shown) provided in the component mounting apparatus 1, and the operation control is carried out in such a manner that a control device 72 drives an air-pressure cylinder control valve 71 provided in the component mounting apparatus 1 (FIG. 9).

Here, in order to couple the carriage 20 to the carriage coupling part 15 of the component mounting apparatus 1, the left and right handles 21 are operated so that the carriage 20 moves into an area of the carriage coupling part 15 in a state where the plurality of parts feeders 8 are mounted to the feeder base 35 of the carriage 20 (the arrow A shown in FIG. 10A). Then, the four cam followers (the left and right front cam followers 37 and the left and right rear cam followers 41) of the carriage 20 are brought into contact with the ascending slope surfaces 52a and 55a of the four cam members (the left and right front cam members 52 and the left and right rear cam members 55) of the component mounting apparatus 1 from the rear at certain positions. Also, the claw portions 38a of the left and right lever members 38 of the carriage 20 are located at a position above the left and right claw lock members 53 of the component mounting apparatus 1. Additionally, the protrusion portion 39 provided in the right lever member 38 of the carriage 20 is located at a position just above the recessed portion 61a of the swingable member 61 of the component mounting apparatus 1 (FIGS. 10B, 11, 12, and 13A).

The carriage coupling part 15 is provided with a sensor 73 (FIG. 9) which detects a state where the right front cam follower 37 is located at a position close to the ascending slope surface 52a of the right front cam member 52 (at a position where the carriage 20 is capable of moving upward) in terms of a contacting or the like and outputs a detection signal. The detection signal output from the sensor 73 is input to the control device 72 provided in the component mounting apparatus 1, and the control device 72 informs an operator of the current state in terms of an alarm 74 (FIG. 9) such as a buzzer or a lamp provided in the component mounting apparatus 1. After the operator is informed that the right front cam follower 37 is located at a position close to the ascending slope surface 52a of the right front cam member 52, when the operator operates a cylinder driving switch 75 (FIG. 9) provided in the component mounting apparatus 1 within a predetermined time, the control device 72 drives the air-pressure cylinder control valve 71 so that the air-pressure cylinder 63 extends (the arrow B shown in FIGS. 13B and 13C).

When the air-pressure cylinder 63 extends, the swingable member 61 swings about the right front protrusion 51 so as to move upward within the upper and lower surfaces (the arrow C shown in FIG. 13), and the upper surface of the recessed portion 61a is brought into contact with the protrusion 39 provided in the right lever member 38 from the downside so as to be pressed upward. Then, the claw portion 38a of the right lever member 38 is brought into contact with the right claw lock member 53 from the upside so that the contact surface serves as a support point, and the right front cam follower 37 rolls on the cam surface of the right front cam member 52 so as to swing upward. On the other hand, the claw portion 38a of the left lever member 38, connected to the right lever member 38 with the connection shaft 36 interposed therebetween, is brought into contact with the left claw lock member 53 from the upside so that the contact surface serves as a support point, and the left front cam follower 37 rolls on the cam surface of the left front cam member 52 so as to swing upward.

Accordingly, the left and right front cam followers 37 roll from the ascending slope surfaces 52a to the horizontal positioning surface 52b of the left and right front cam members 52, respectively, thereby enabling the connection shaft 36 to move forward along the shape of the cam surfaces of the left and right cam members 52 in a horizontal posture. Specifically, the connection shaft 36 moves forward in an ascending direction when the left and right front cam followers 37 roll on the ascending slope surfaces 52a of the left and right front cam members 52, and moves forward in a horizontal direction when the left and right front cam followers 37 roll on the positioning surfaces 52b of the left and right front cam members 52.

Likewise, when the connection shaft 36 moves forward as a whole, the feeder base 35 supporting the connection shaft 36 is hauled forward by the connection shaft 36, on the other hand, the left and right rear cam followers 41 roll from the ascending slope surfaces 55a to the horizontal positioning surface 55b of the left and right rear cam members 55, thereby enabling the feeder base 35 to move forward in a horizontal posture as a whole. During the time when the feeder base 35 moves forward as a whole, the carriage body portion 22, connected to the feeder base 35 with the vertical pillars 28 interposed therebetween, moves forward in such a manner that the vehicle wheels 24 roll on the bottom surface. However, since the feeder base 35 is configured to be elevatable with respect to the carriage body portion 22 with the vertical pillars 28 interposed therebetween, the feeder base 35 moves upward with respect to the carriage body portion 22 while moving forward.

The upper surfaces of the left carriage support member 13 and the right carriage support member 14 are provided with left and right stoppers 64 (see FIGS. 7 and 13), respectively, and an operation in which the feeder base 35 is positioned with respect to the carriage coupling part 15 in a longitudinal direction is carried out at the positions where the left and right front cam followers 37 are brought into contact with the left and right stoppers 64 from the rear, respectively. At this time, the four cam followers (the left and right front cam followers 37 and the left and right rear cam followers 41) provided in the feeder base 35 are respectively placed on the positioning surfaces 52b and 55b of the four cam members (the left and right cam members 52 and the left and right rear cam members 55) provided in the component mounting apparatus 1, the feeder base 35 is coupled to the component mounting apparatus 1 while being positioned with respect to the component mounting apparatus 1 in a height direction. Additionally, since the left and right front cam followers 37 are pressed by the left and right stoppers 64 in terms of the air-pressure cylinder 63 in a state where the feeder base 35 is coupled to the component mounting apparatus 1, the cam followers 37 and 41 of the feeder base 35 cannot roll on the cam surfaces of the cam members 52 and 55 in an inverse direction, and thus the coupling action between the feeder base 35 and the component mounting apparatus 1 cannot be released.

Additionally, although the feeder base 35 moves forward in a horizontal direction before ending the coupling action between the carriage 20 and the component mounting apparatus 1, as the feeder base 35 moves in a horizontal direction, a carriage-side connector 42 (FIG. 5) provided in the bridge portion 32 of the feeder base 35 is fitted to an apparatus-side connector 65 (FIG. 7) provided in the component mounting apparatus 1 in a horizontal direction. When the carriage-side connector 42 is fitted to the apparatus-side connector 65, a power source on the side of the component mounting apparatus 1 can be used as a power source for a device (for example, the parts feeder 8) on the side of the carriage 20.

The carriage positioning mechanism of the component mounting apparatus 1 according to the invention is used to position the parts feeder 35 of the carriage 20 in a height direction when the carriage 20 is coupled to the component mounting apparatus 1, the parts feeder corresponding to a positioning object portion, and includes the cam followers 37 and 41 which are rotatably provided in the periphery of the horizontal shaft of the feeder base 35; the cam members 52 and 55 which are provided in the component mounting apparatus 1 and includes the ascending slope surfaces 52a and 55a coming into contact with the cam followers 37 and 41 when the carriage 20 is close to the component mounting apparatus 1 and the horizontal positioning surfaces 52b and 55b continuously formed with the ascending slope surfaces 52a and 55a; and the air-pressure cylinder 63 which is provided in the component mounting apparatus 1 and presses upward the feeder base 35 toward the component mounting apparatus 1 after the cam followers 37 and 41 are brought into contact with the ascending slope surfaces 52a and 55a of the cam members 52 and 55 so that the cam followers 37 and 41 roll from the ascending slope surfaces 52a and 55a to the positioning surfaces 52b and 55b of the cam members 52 and 55 and the feeder base 35 is placed on the positioning surfaces 52b and 55b of the cam members 52 and 55.

In the carriage positioning mechanism with such a configuration, since the air-pressure cylinder 63 as the actuator performs an operation in which the carriage 20 is pressed upward against a force that the cam followers 37 and 41 mounted to the feeder base 35 corresponding to the positioning object portion of the carriage 20 move downward along the ascending slope surfaces 52a and 55a of the cam members 52 and 55, it is possible for the operator to easily couple the carriage 20 to the component mounting apparatus 1.

Since the air-pressure cylinder 63 is provided on the side of the component mounting apparatus 1 instead of the carriage 20, it is not necessary to provide the air-pressure cylinder 63 for each carriage 20, thereby reducing a manufacture cost.

Additionally, in the carriage positioning mechanism for the component mounting apparatus 1 according to this embodiment, the carriage-side connector 42 is configured to be fitted to the apparatus-side connector 65 in a horizontal direction, and the both connectors 42 and 65 are fitted to each other by using the horizontal movement of the feeder base 35 in which the cam followers 37 and 41 provided in the feeder base 35 corresponding to the positioning object portion of the carriage 20 roll on the horizontal positioning surfaces 52b and 55b. For this reason, waste or dust hardly enters the connectors 42 and 65, thereby preventing an occurrence of a problem such as a bad connection. Since the both connectors 42 and 65 are automatically fitted to each other upon performing the positioning operation of the feeder base 35 of the carriage 20 in a horizontal direction, it is not necessary for the operator to perform the fitting operation between the both connectors 42 and 65 after coupling the carriage 20 to the component mounting apparatus 1, thereby improving the operability.

In order to separate the carriage 20 coupled to the component mounting apparatus 1 from the component mounting apparatus 1, the cylinder driving switch 75 is operated so that the air-pressure cylinder 63 retracts and the swingable member 61 swings in a direction opposite to a direction indicated by the arrow B shown in FIGS. 13B and 13C to return to the initial position (the position shown in FIG. 13A). Subsequently, the left and right handles 21 are pulled in a direction in which the carriage 20 moves away from the component mounting apparatus 1. Accordingly, the four cam followers 37 and 41 on the side of the carriage 20 placed on the positioning surfaces 52b and 55b of the four cam members 52 and 55 roll from the positioning surfaces 52b and 55b to the ascending slope surfaces 52a and 55a in a descending direction, thereby separating the carriage 20 from the component mounting apparatus 1. Additionally, in this operation, since the feeder base 35 moves in a horizontal direction so as to move away from the component mounting apparatus 1, the carriage-side connector 42 is separated from the apparatus-side connector 65.

While the exemplary embodiment of the invention has been described, the invention is not limited to the above-described embodiment. For example, in the above-described embodiment, although the carriage 20 coupled to the component mounting apparatus 1 is the parts feeder changing carriage, this is just an example, but the carriage 20 may be a carriage used for other purposes, for example, a carriage mounted with a personal computer and the like for checking the operation of the component mounting apparatus 1. Additionally, in the above-described embodiment, although the number of the cam followers 37 and 41 provided on the side of the positioning object portion (the feeder base 35 in the above-described example) of the carriage 20 is four and the number of the cam members 52 and 55 provided on the side of the component mounting apparatus 1 is four, this is just an example, but the number is not limited to four, respectively.

In the above-described embodiment, although the ascending slope surface 52a of the front cam member 52 is formed into the circular-arc surface and the ascending slope surface 55a of the rear cam member 55 is formed into the slope surface, the shape of the ascending slope surface (the surface inclined from the rear to the front in an ascending direction) is not limited to those of the circular-arc surface or the slope surface. Additionally, the combination of the shapes of the ascending slope surfaces of the front cam member 52 and the rear cam member 55 is not limited to the above-described embodiment, but may be set arbitrarily.

In the above-described embodiment, although the air-pressure cylinder 63 swings the swingable member 61 so that the protrusion 39 provided on the side of the feeder base 35 is pressed upward and the cam followers 37 and 41 roll from the ascending slope surfaces 52a and 55a to the positioning surfaces 52b and 55b of the cam members 52 and 55, the air-pressure cylinder 63 may be changed with other actuators. Additionally, the mechanism for enabling the cam followers 37 and 41 to roll from the ascending slope surfaces 52a and 55a to the positioning surfaces 52b and 55b of the cam members 52 and 55 is not limited to the mechanism shown in the above-described embodiment.

In the above-described embodiment, although the positioning object portion (the feeder base 35) of the carriage 20 is configured to be elevatable with respect to the carriage body portion 22 of the carriage 20, the positioning object portion of the carriage may not be elevatable with respect to the carriage body portion, but may be integrally formed with the carriage body portion. In this case, when the positioning object portion of the carriage is pressed upward toward the component mounting apparatus, the whole part of the carriage is pressed upward together with the carriage body portion.

In the above-described embodiment, although a case has been described in which the invention is applied to the exemplary component mounting apparatus, the invention is not limited to the component mounting apparatus, but may be applied to a printing apparatus or an inspection apparatus instead of the component mounting apparatus.

It is possible to facilitate the coupling operation in which the carriage is coupled to the component mounting apparatus.

What is claimed is:

1. A carriage positioning mechanism for a component mounting apparatus for positioning a positioning object portion of a carriage in a height direction upon coupling the carriage to the component mounting apparatus, the mechanism comprising:
a cam follower rotatably provided in a periphery of a horizontal shaft of the positioning object portion;
a cam member provided in the component mounting apparatus and including an ascending slope surface coming into contact with the cam follower when the carriage is close to the component mounting apparatus and a horizontal positioning surface continuously formed with the ascending slope surface; and
an actuator which is provided in the component mounting apparatus and presses upward the positioning object portion of the carriage toward the component mounting apparatus after the cam follower comes into contact with the ascending slope surface of the cam member so that the cam follower rolls from the ascending slope surface to the positioning surface of the cam member and the positioning object portion is placed on the positioning surface of the cam member.

2. A carriage for a component mounting apparatus having a positioning object portion positioned in a height direction upon being coupled to the component mounting apparatus, the carriage comprising:
a cam follower which is rotatably provided in a periphery of a horizontal shaft of the positioning object portion and comes into contact with an ascending slope surface of a cam member provided in the component mounting apparatus at a position close to the component mounting apparatus,
wherein the cam follower comes into contact with the ascending slope surface of the cam member and the positioning object portion is pressed upward toward the component mounting apparatus by an actuator provided in the component mounting apparatus so that the cam follower rolls from the ascending slope surface of the cam member to a horizontal positioning surface continuously formed with the ascending slope surface, thereby placing the positioning object portion on the positioning surface of the cam member.

3. A carriage positioning mechanism for a component mounting apparatus for positioning a positioning object portion of a carriage in a height direction upon coupling the carriage to the component mounting apparatus, the mechanism comprising:
a cam follower rotatably provided in a periphery of a horizontal shaft of the positioning object portion;
a cam member provided in the component mounting apparatus and including an ascending slope surface coming into contact with the cam follower when the carriage is close to the component mounting apparatus and a horizontal positioning surface continuously formed with the ascending slope surface;
an actuator which is provided in the component mounting apparatus and presses upward the positioning object portion of the carriage toward the component mounting apparatus after the cam follower comes into contact with the ascending slope surface of the cam member so that the cam follower rolls from the ascending slope surface to the positioning surface of the cam member and the positioning object portion is placed on the positioning surface of the cam member;
a carriage-side connector which is provided in the positioning object portion of the carriage; and
an apparatus-side connector provided in the component mounting apparatus and fitted to the carriage-side connector in a horizontal direction,
wherein when the cam follower rolls on the positioning surface of the cam member, the positioning object portion of the carriage moves in a horizontal direction so that the carriage-side connector is fitted to the apparatus-side connector in a horizontal direction.
